(19) United States
(12) Patent Application Publication
(10) Pub. No.: US 2010/0185544 A1
(43) Pub. Date: Jul. 22, 2010

(54) Method and System for Making a Payment Through a Mobile Communication Device

(76) Inventor: Ajay Adiseshann, Maharashtra (IN)

Correspondence Address: LESTER H. BIRNBAUM, 6 OAKMOUNT COURT, SIMPSONVILLE, SC, 29681, US

(21) Appl. No.: 11/922,751

(22) PCT Filed: Oct. 27, 2006
(86) PCT No.: PCT/IN2006/000433

§ 371 Date: Dec. 21, 2007

(30) Foreign Application Priority Data
Jan. 20, 2006 (IN) 98/MUM/2006

(51) Int. Cl. G06Q 20/00; H04W 4/12; H04M 3/42

(52) U.S. Cl. 705/44; 455/466; 455/414.1

(57) ABSTRACT

A method for making a payment through a mobile communication device, the method comprising:
a. receiving transaction details of the payment by a Paymate, the transaction details being received from a payee, the transaction details comprising at least one of a transaction identifier and a transaction amount;
b. sending a text message to the Paymate, the text message being sent by a payer, the text message comprising at least one of the transaction identifier, the transaction amount and a Personal Identification Number (PIN) of the payer;
c. verifying the text message on the Paymate, the text message being verified with the transaction details received by the Paymate;
d. authenticating the payer on the Paymate, the authentication of the payer being based on at least one of an identification number of the mobile communication device, the PIN of the payer and the transaction amount, wherein the identification number of the mobile communication device is sent along with the text message; and
e. sending a debit request to a debit server for debiting the transaction amount from an account of the payer, the account being located at the debit server, the debit server receiving the debit request from the Paymate.

The present invention relates to a method for making a payment through a mobile communication device.

### BACKGROUND OF THE INVENTION

With the rapid development of trade and commerce across the world, most of the financial institutions are becoming computerized. Computerization helps these financial institutions to automate their internal businesses as well as subsequently substitute the existing manual labor requirements to perform transactions. Traditional exercises such as manual clearance of cheques and depositing of cash is now being replaced by an automated, computer-based transaction system, which is a step toward cashless-payment transactions.

The present technology drive for a cashless-payment system is geared towards the use of mobile communication devices to make financial transactions. The use of mobile communication devices for making payments expedites the transaction and also saves time required for a person to go to a bank and do the paperwork. Further, from a buyer's and a seller's perspective, the transaction is complete on the point-of-sale, making the payment using a mobile communication device safer and faster.

Various methods have been proposed for making a payment by using a mobile communication device. One of the methods for making payments by using mobile communication devices uses embedded software. The embedded software provides a user interface, which may be used by a buyer to select different fields and enter the details required to make a payment. Most of these softwares are provided in the relatively more expensive mobile communication devices. Moreover, some of the embedded softwares require an Internet connection for completing the transaction. Additionally, some embedded softwares may not be compatible with the different mobile communication service providers.

Another method for making a payment by using mobile communication devices provides a buyer with an option of making a payment by using his prepaid credit. The prepaid credit is the amount of money paid by the buyer to a service provider for his mobile communication device. Consequently, the buyer cannot make purchases worth more than the total amount of his prepaid credit. Further, the buyer has to remember various details, like credit account number, validation period, and so forth, required for making a payment.

In light of the above discussion, there is a need for a method and a system, which enables buyers to make payments by using various mobile communication devices. Further, there is a need for a method and a system, which does not restrict a buyer to make the payment by using his mobile communication device, based on his prepaid credit.

### SUMMARY OF THE INVENTION

An object of the invention is to provide a method for payment, using a mobile communication device.

Another object of the invention is to provide a method for payment through a Short Messaging Service (SMS), using a mobile communication device. The payment is independent of any mobile communication service provider.

Yet another object of the invention is to provide a system for payment through an SMS, using a mobile communication device, which is independent of any embedded software on the mobile communication device.

Still another object of the invention is to provide a system for payment through an SMS, using a mobile communication device, which is independent of the mobile communication's option of prepaid credit.

To achieve the above mentioned objectives, the invention provides a method and a system wherein a payer can make a payment for a purchase of an item by using his mobile communication device through ‘Paymate’. Paymate is a unique mobile payment platform and an ecosystem that is conceived, developed and implemented by the applicant to facilitate payer to payee payments using a mobile communication device and allowing the mobile communication device to function as a virtual debit, credit card or bank account. The method includes sending a purchase request to the Paymate with the transaction details. A payee may also send the transaction identifier and the transaction amount to the Paymate, if the payer is purchasing at least one item from the payee. The Paymate verifies the transaction details and authenticates the payer. After verification and authentication, the Paymate sends the request to a debit server such as a bank, for debiting the transaction amount from the payer's account and crediting the transaction amount to the payee's account. In response, the Paymate then sends a confirmatory message to the payer and the payee stating the status of the transaction.

A method for making a payment through a mobile communication device, the method comprising:
a. receiving transaction details of the payment by a Paymate, the transaction details being received from a payee, the transaction details comprising at least one of a transaction identifier and a transaction amount;
b. sending a text message to the Paymate, the text message being sent by a payer, the text message comprising at least one of the transaction identifier, the transaction amount and a Personal Identification Number (PIN) of the payer;
c. verifying the text message on the Paymate, the text message being verified with the transaction details received by the Paymate;
d. authenticating the payer on the Paymate, the authentication of the payer being based on at least one of an identification number of the mobile communication device, the PIN of the payer and the transaction amount, wherein the identification number of the mobile communication device is sent along with the text message; and
e. sending a debit request to a debit server for debiting the transaction amount from an account of the payer, the account being located at the debit server, the debit server receiving the debit request from the Paymate.

### BRIEF DESCRIPTION OF THE DRAWINGS

Additional features and advantages of the invention become clear from the following description and drawing:

FIG. 1 is a schematic representation of a payment, using a mobile communication device through a Paymate, in accordance with various embodiments of the invention;

FIG. 2 is a schematic representation of a payment, using a mobile communication device through Paymate, in accordance with an embodiment of the invention;

FIG. 3 is a schematic representation of a payment, using a mobile communication device through Paymate, in accordance with another embodiment of the invention;

FIG. 4 is a block diagram illustrating the functional modules of Paymate, in accordance with an embodiment of the invention; and

FIG. 5 is a flowchart depicting a method for making a payment using a mobile communication device through Paymate, in accordance with an embodiment of the invention.

### DESCRIPTION OF PREFERRED EMBODIMENTS

Various embodiments of the invention provide a method and a system for making a payment by using a mobile communication device. The method includes a payer making payment(s) to a payee. The payer sends a text message such as a Short Messaging Service (SMS), hereinafter referred to as an SMS, to a Paymate with transaction details for the payment. The Paymate is a unique mobile payment platform and an ecosystem that is conceived, developed and implemented to facilitate payer to payee payments using a mobile communication device and allowing the mobile communication device to function as a virtual debit, credit card or bank account. The Paymate processes the transaction details and sends a debit request to a debit server for debiting the transaction amount from the payer's account and crediting the transaction amount to the payee's account.

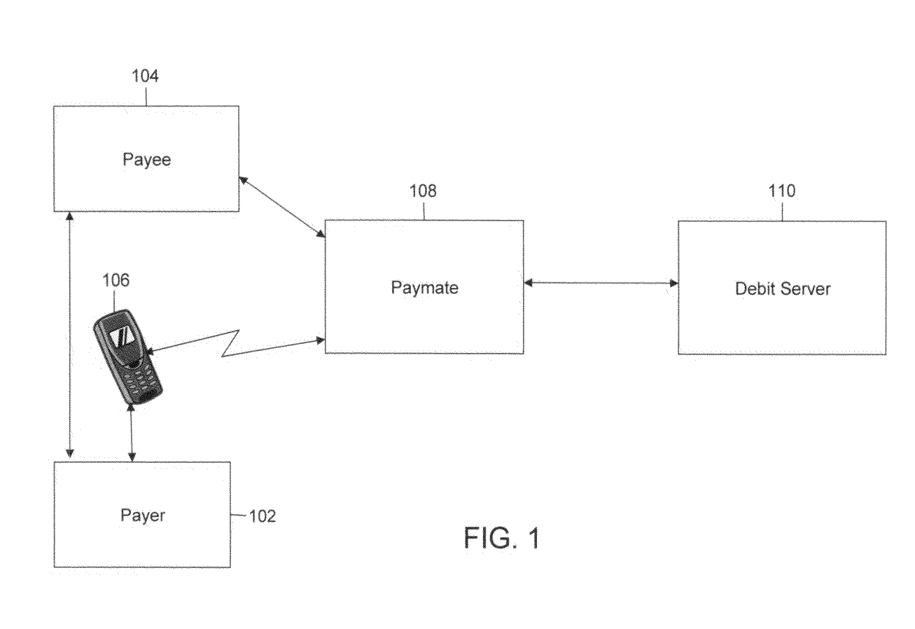

FIG. 1 is a schematic representation of a payment, using a mobile communication device 106 through a Paymate 108, in accordance with various embodiments of the invention. FIG. 1 includes a payer 102, a payee 104, mobile communication device 106, Paymate 108 and a debit server 110. Payer 102 makes a payment to payee 104, using mobile communication device 106. Payer 102 sends a payment request through an SMS to Paymate 108. Paymate 108 processes the payment request. Thereafter, Paymate 108 sends a debit request to debit server 110.

In an embodiment of the invention, payer 102 may purchase an item from payee 104. Payer 102 chooses an option for payment against the purchase of the item by using mobile communication device 106. In another embodiment of the invention, payer 102 may make any personal payment, which does not involve the purchase of an item, to payee 104, using mobile communication device 106 through Paymate 108. In various embodiments of the invention, mobile communication device 106 may be a mobile phone, a landline telephone, a Personal Digital Assistant (PDA), and so forth. In various embodiments of the invention, Paymate 108 may be implemented in the form of software, hardware, firmware or combinations thereof.

In various embodiments of the invention, payer 102 may send an SMS to Paymate 108 for making a payment request. In an embodiment of the invention, the SMS may include a transaction identifier, a transaction amount and a Personal Identification Number (PIN) of payer 102. In various embodiments of the invention, the transaction identifier may be a unique number which is generated by payee 104 for the purchase of the item. In an embodiment of the invention, payee 104 may also send the transaction identifier and the transaction amount to Paymate 108 through the SMS.

In various embodiments of the invention, payer 102 may send the SMS to a short code. Short code is a number provided by Paymate 108. For example, Paymate 108 may have ‘1111’ as a short code and every SMS sent to ‘1111’ reaches. Paymate 108. The short code is the same for all mobile communication service providers. In an embodiment of the invention, payee 104 may provide the short code to payer 102.

In an embodiment of the invention, payer 102 can download a software/application on mobile communication device 106. The software/application can provide a Graphical User Interface (GUI) on mobile communication device 106 for sending transaction details to Paymate 108. The software/application enables payer 102 connects to Paymate 108 over secure protocols, such as Wireless Application Protocol (WAP), Binary Runtime Environment for Wireless (BREW) and so forth. Payer 102, after connecting with Paymate 108, sends the transaction details to Paymate 108. Thereafter, Paymate 108 processes the payment request as described above. Paymate 108, after processing the payment request, sends a response to the software/application to mobile communication device 106 on the status of the payment request.

In various embodiments of the invention, payee 104 may generate a transaction identifier for the purchase of an item. Payee 104 notifies the transaction identifier to payer 102. In an embodiment of the invention, payee 104 may notify the transaction identifier to payer 102 by sending an SMS. In another embodiment of the invention, payee 104 may notify the transaction identifier to payer 102 in person. In various embodiments of the invention, payee 104 may be a telemarketing vendor, a shop owner, an ordinary person, and so forth. In an embodiment of the invention, payee 104 may provide the details to payer 102 required for the SMS to be sent to Paymate 108.

Paymate 108 processes the payment request received from payer 102. Paymate 108 sends the payment request along with the transaction amount to debit server 110, after the payment request has been processed.

Debit server 110 debits the transaction amount from an account of payer 102. Further, debit server 110 credits the transaction amount to an account of payee 104. Debit server 110 sends a message regarding the completion of the transaction after debiting and crediting the transaction amount from the accounts of payer 102 and payee 104, respectively, to Paymate 108. Thereafter, Paymate 108 sends a confirmatory message to payer 102 and payee 104, declaring the transaction to be complete.

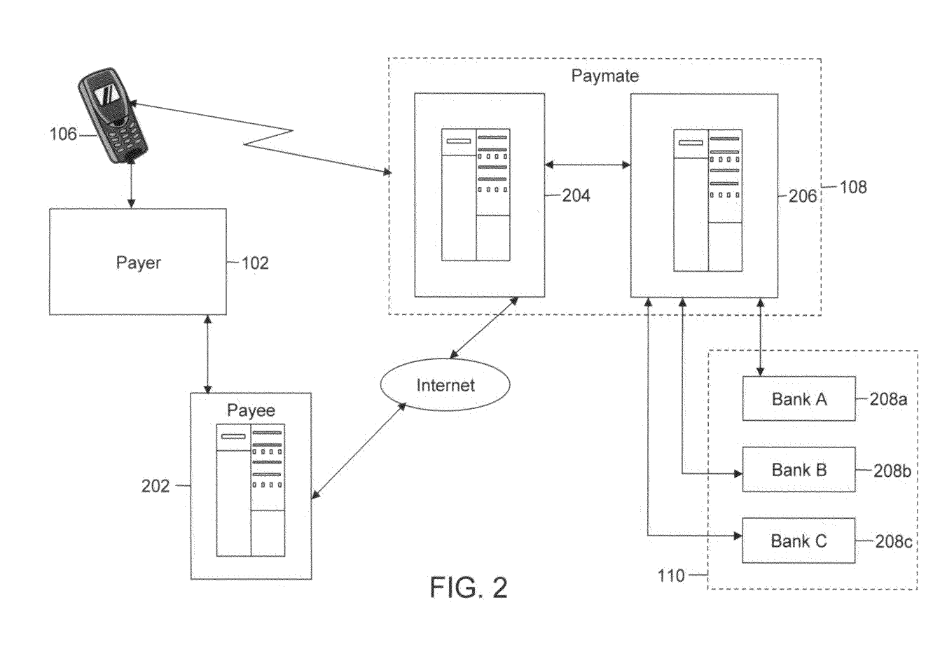

FIG. 2 is a schematic representation of a payment, using a mobile communication device 106 through Paymate 108, in accordance with an embodiment of the invention. FIG. 2 includes payer 102, mobile communication device 106, a payee 202, Paymate 108, and debit server 110. Paymate 108 includes a first server 204, and a second server 206. Debit server 110 includes Bank A 208a, Bank B 208b, and bank C 208c. In various embodiments of the invention, payer 102 makes a payment to payee 202. In an embodiment of the invention, payee 202 may be an online shopping website where payer 102 purchases an item. Payer 102 chooses an option for payment with the mobile communication device 106 on the website.

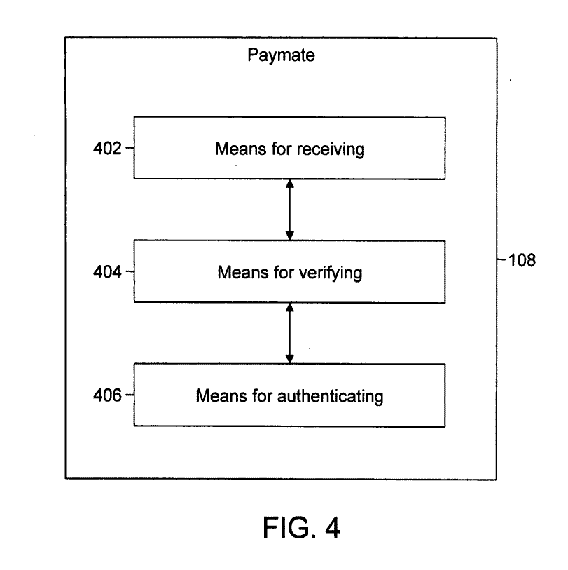

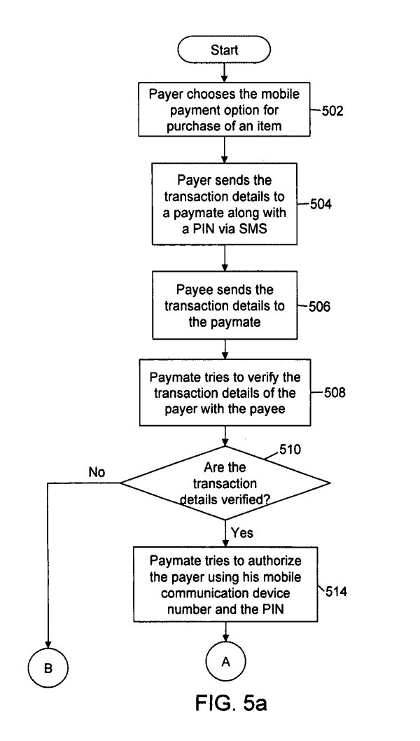

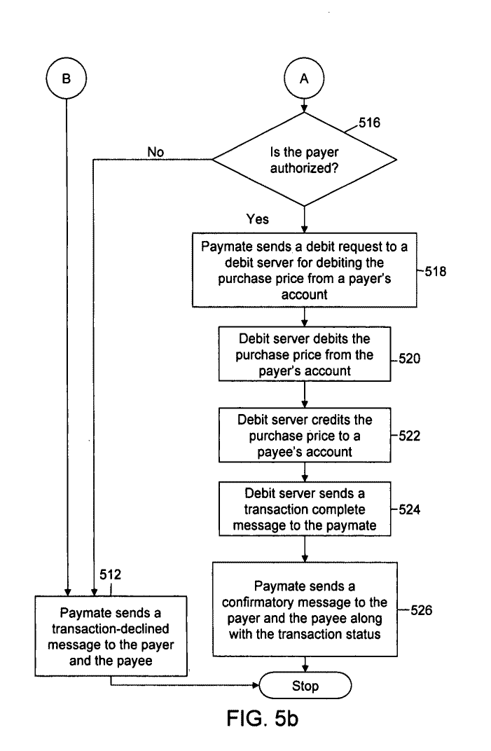

Payer 102 sends a payment request through an SMS to Paymate 108 with the transaction identifier, the transaction amount and the PIN. Paymate 108 processes the payment request as described in conjunction with FIG. 4 and FIG. 5. Thereafter, Paymate 108 sends a debit request to debit server 110. The debit request includes the transaction amount to be debited from the account of payer 102 and credited to the account of payee 202.

In various embodiments of the invention, payer 102 has to register with debit server 110 for making the payment through Paymate 108. Payer 102 provides details to debit server 110. In an embodiment of the invention, these details may include the identification number of mobile communication device 106, the account number, the name of payer 102, and so forth. In various embodiments of the invention, debit server 110 may provide a PIN to payer 102 for making transactions using mobile communication device 106. Paymate 108 also receives the details of payer 102 from debit server 110, after payer 102 registers with debit server 110. Similarly, payee 202 may also register with debit server 110 and Paymate 108. In an embodiment of the invention, payer 102 registers with Paymate 108 by providing the identification number of mobile communication device 106 to Paymate 108. In an embodiment of the invention, Paymate 108 provides the PIN to payer 102.

In various embodiments of the invention, Paymate 108 stores the PIN along with identification number of mobile communication device 106.

In various embodiments of the invention, Paymate 108 stores the information received through the SMS from payer 102. In an embodiment of the invention, Paymate 108 may be implemented on one or more servers. For example, in FIG. 2, Paymate 108 is implemented on first server 204 and second server 206.

In an embodiment of the invention, the accounts of payer 102 and payee 202 may be maintained at debit server 110. In various embodiments of the invention, the accounts of payer 102 and payee 202 may be savings account, current account, credit account, and so forth.

In various embodiments of the invention, debit server 110 may be a bank. In an embodiment of the invention, debit server 110 may include one or more banks. For example, debit server 110 includes Bank A 208a, Bank B 208b and Bank C 208c. Payer 102 may also send the bank details through the SMS, for example, the details of Bank A 208a, Bank B 208b or Bank C 208c, in accordance with the above embodiment.

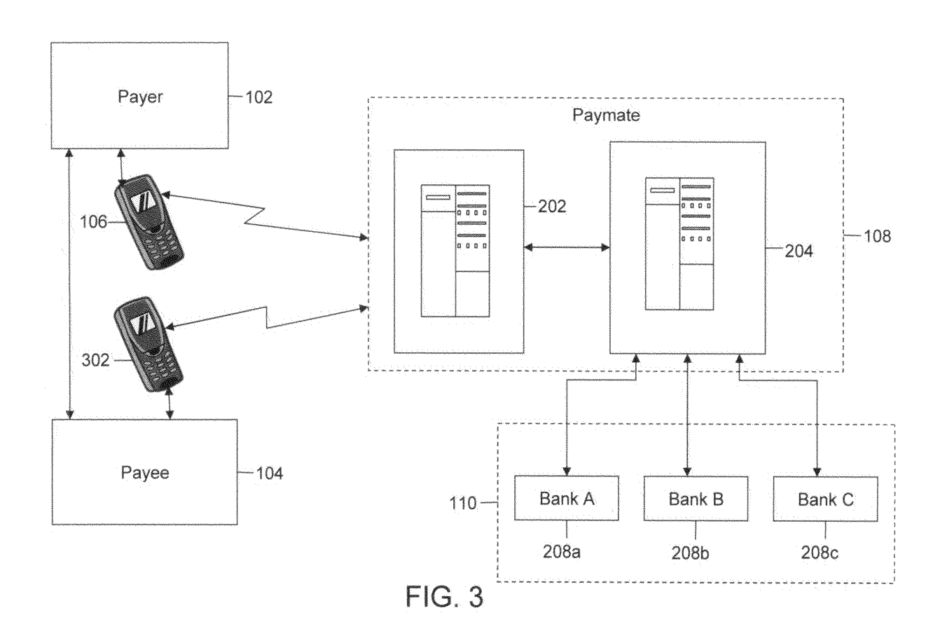

FIG. 3 is a block diagram, illustrating a payment made by using mobile communication device 106 through Paymate 108, in accordance with another embodiment of the invention. FIG. 3 includes a mobile communication device 302 and various other elements. The other elements in FIG. 3 are the same as mentioned in conjunction with FIG. 2.

In an embodiment of the invention, payer 102 may select an item for purchase and choose to pay with mobile communication device 106 by interacting with payee 104, using mobile communication device 106, wherein payee 104 is a telemarketing vendor. In another embodiment of the invention, payer 102 may make the purchase and the choice for payment for the purchase of the item over a telephone. In yet another embodiment of the invention, payer 102 may make the choice for payment by using mobile communication device 106 in person with a shop owner.

In an embodiment of the invention, payee 104 generates the transaction identifier for the purchase of the item. Further, payee 104 notifies the transaction identifier to payer 102. In an embodiment of the invention, payee 104 may notify the transaction identifier to payer 102 by using mobile communication device 302. In another embodiment of the invention, payee 104 may notify the transaction identifier, short code, and the SMS details to payer 102 through the Internet.

Paymate 108 processes the payment request in a similar manner as described in conjunction with FIG. 2.

FIG. 4 is a block diagram illustrating the functional modules of Paymate 108. Paymate 108 includes a means for receiving 202, a means for verifying 204 and a means for authenticating 206.

Means for receiving 402 receives the SMS from payer 102. The SMS includes transaction identifier for the payment, transaction amount and PIN of payer 102. In an embodiment of the invention, means for receiving 402 may receive the transaction details from payee 104. In various embodiments of the invention, transaction details from payee 104 may include transaction identifier and transaction amount. In various embodiments of the invention, means for receiving 402 may be implemented in the form of software, hardware, firmware or combinations thereof.

Means for verifying 404 verifies the SMS with the transaction details received from payee 104. In an embodiment of the invention, means for verifying 404 compares the transaction identifier and the transaction amount sent in the SMS by payer 102 and the transaction details sent by payee 104. Paymate 108 sends a transaction-declined message to payer 102 and payee 104, if the verification fails. Means for authenticating 404 tries to authenticate payer 102, if the verification is successful. In various embodiments of the invention, means for verifying 404 may be implemented in the form of software, hardware, firmware or combinations thereof.

Means for authenticating 406 authenticates payer 102, based on the PIN and the identification number of mobile communication device 106, which is received along with the SMS. Paymate 108 sends a debit request to debit server 110 for debiting the transaction amount from the account of payer 102 and crediting the transaction amount in the account of payee 104, if payer 102 is authenticated. Paymate 108 sends a transaction-declined message to payer 102 and payee 104, if the authorization of payer 102 fails. In various embodiments of the invention, means for authenticating 406 may be implemented in the form of software, hardware, firmware or combinations thereof.

FIG. 5 is a flowchart depicting a method for making a payment request, using mobile communication device 106 through Paymate 108, in accordance with an embodiment of the invention. At 502, a payer, such as payer 102, chooses an option of payment by using his mobile communication device, such as mobile communication device 106. The payer makes a payment to a payee, such as payee 104. In various embodiments of the invention, the payee may be an online shopping website, a telemarketing vendor, a shop owner, an ordinary, and so forth. In an embodiment of the invention, the payer may purchase at least one item from the payee. In another embodiment of the invention, the payer may make a personal payment, which does not involve the purchase of an item, to the payee by using his mobile communication device through the Paymate.

In various embodiments of the invention, a transaction identifier is generated to purchase the item. In an embodiment of the invention, the payee may generate the transaction identifier. The payee may notify the transaction identifier to the payer by displaying the transaction identifier on the online shopping website, by e-mailing the transaction identifier to the payer; by using his mobile communication device, such as mobile communication device 302; by using a telephone, and so forth.

In an embodiment of the invention, the payee may notify the details to the payer required for an SMS to be sent to a Paymate, such as Paymate 108, by displaying the information on the online shopping website, by e-mailing the transaction identifier to the payer, by using his mobile communication device, by using a telephone, and so forth.

At 504, the payer makes a payment request to the Paymate by sending an SMS that contains the transaction identifier, transaction amount and PIN to the Paymate. At 506, the payee sends the transaction identifier and the transaction amount to the Paymate. In various embodiments of the invention, the payee may send the transaction identifier and the transaction amount to the Paymate by using his mobile communication device, through the Internet, by using a telephone, and so forth. In an embodiment of the invention, a keyword, for example, ‘pay’ may be used by the payer in the SMS to make a payment the payee, i.e., a person. The identification number of the mobile communication device of the payee is also sent to the Paymate along with the keyword, transaction amount and PIN through the SMS.

At 508, the Paymate tries to verify the transaction details received from the payer. In an embodiment of the invention, the Paymate tries to verify the transaction details received from the payer and the payee. At 510, it is checked if the transaction details have been verified. The transaction details may not be verified, if all the required details in the SMS are not received by the Paymate. In an embodiment of the invention, the verification may fail if there is a mismatch between the transaction details received from the payer and the payee. For example, if the transaction identifier sent by the payer is not the same as the one sent by the payee, then the verification fails.

If the transaction details are not verified at 510, then 512 is performed. At 512, the Paymate sends a transaction-declined message to the payer and the payee. Thereafter, the transaction is terminated.

If the transaction details are verified at 510, then 514 is performed. At 514, the Paymate tries to authenticate the payer by using his mobile communication device number and PIN. At 516, it is checked if the payer is authenticated. In various embodiments of the invention, the Paymate compares the identification number of the mobile communication device and the PIN received from the payer with the identification number of the mobile communication device and the PIN stored at the Paymate for authenticating the payer. If the payer is not authenticated at 516, then 512 is performed.

If the payer is authenticated at 516, then 518 is performed. At 518, the Paymate sends a debit request to a debit server, such as debit server 110 for debiting the transaction amount from the account of the payer and crediting the transaction amount to the account of the payee. In various embodiments of the invention, the accounts of the payer and the payee are maintained at the debit server. The accounts of the payer and the payee may be a savings account, a current account, a credit account, and so forth.

At 520, the transaction amount is debited from the account of the payer. At 522, the debit server credits the transaction amount in the account of the payee. At 524, the debit server sends a confirmatory message to the Paymate with the status of the transaction. In various embodiments of the invention, the status of the transaction may include the transaction successful message along with the information related to the debit amount for the payer and the amount to be credited to the payee, respectively. At 526, the Paymate sends the confirmatory message to the payer and the payee. The confirmatory message indicates that the transaction is complete. In various embodiments of the invention, the Paymate may send the confirmatory message to the payer and the payee by displaying the confirmatory message on the online shopping website, by means of an SMS, and so forth.

Various embodiments of the invention provide a number of advantages. In accordance with various embodiments of the invention, a payer can make a cashless transaction from his debit or credit server account by using his mobile communication device. The payer does not have to reveal his debit server account or credit card details to the payee which makes the transaction fast and secure. Further, the payer does not require a mobile communication device with embedded software to make a payment.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

We claim:

1. A method for making a payment through a mobile communication device, the method comprising:
a. receiving transaction details of the payment by a Paymate, the transaction details being received from a payee, the transaction details comprising at least one of a transaction identifier and a transaction amount;
b. sending a text message to the Paymate, the text message being sent by a payer, the text message comprising at least one of the transaction identifier, the transaction amount and a Personal Identification Number (PIN) of the payer;
c. verifying the text message on the Paymate, the text message being verified with the transaction details received by the Paymate;
d. authenticating the payer on the Paymate, the authentication of the payer being based on at least one of an identification number of the mobile communication device, the PIN of the payer and the transaction amount, wherein the identification number of the mobile communication device is sent along with the text message; and
e. sending a debit request to a debit server, the debit request being sent by the Paymate for debiting the transaction amount from an account of the payer, wherein the account is located at the debit server.

2. A system performing the method as claimed in claim 1, the system comprising the Paymate, the Paymate comprising:
a. means for receiving, the means for receiving at least one of the text message from the payer, and the transaction details from the payee;
b. means for verifying the text message, the text message being verified with the transaction details received by the means for receiving; and
c. means for authenticating the payer, the authentication being based on at least one of the identification number of the mobile communication device, the PIN and the transaction amount, wherein the means for authenticating sends a debit request, based on the authentication, along with the transaction amount to the debit server.

3. The system as claimed in claim 2, wherein the PIN is provided to the payer by the debit server.

4. The system as claimed in claim 2, wherein the PIN is provided to the payer by the Paymate.

5. The system as claimed in claim 2, wherein a transaction-declined message is sent by the Paymate to at least one of the payer and the payee, the transaction-declined message being sent if the verification of the text message fails.

6. The system as claimed in claim 2, wherein a transaction-declined message is sent by the Paymate to at least one of the payer and the payee, the transaction-declined message being sent if the authentication of the payer fails.

7. The system as claimed in claim 2, wherein a transaction-declined message is sent by the debit server to the Paymate, the transaction-declined message being sent if the account of the payer cannot be debited for the transaction amount.

8. The system as claimed in claim 7, wherein the transaction-declined message is sent by the Paymate to at least one of the payer and the payee.

9. The system as claimed in claim 2, wherein a transaction complete message is sent from the debit server to the Paymate, the transaction complete message being sent after the transaction amount has been debited from the account of the payer.

10. The system as claimed in claim 10, wherein a confirmatory message is sent by the Paymate to at least one of the payer and the payee, the confirmatory message being sent after receiving the transaction complete message from the debit server, the confirmatory message comprising transaction status details.

11. A method for making a payment through a mobile communication device such as herein described with reference to the description and the accompanying drawings.
